(19) United States
(12) Patent Application Publication
(10) Pub. No.: US 2022/0019976 A1
(43) Pub. Date: Jan. 20, 2022

(54) SYSTEM AND METHOD TO IDENTIFY, MATCH, AND RANK CANDIDATES FOR TALENT ACQUISITION

(71) Applicant: INTERNATIONAL BUSINESS MACHINES CORPORATION, ARMONK, NY (US)

(72) Inventors: Karina Elayne Kervin, Sacramento, CA (US); Ying Li, Mohegan Lake, NY (US); Anshul Sheopuri, Oradell, NJ (US)

(21) Appl. No.: 16/947,122

(22) Filed: Jul. 20, 2020

(51) Int. Cl. G06Q 10/10

(52) U.S. Cl. CPC G06Q 10/1053

(57) ABSTRACT

Embodiments of the present invention disclose a method, computer program product, and system for talent acquisition. A method comprises receiving a job application from an Applicant, wherein the job application includes a resume and analyzing the job applicant of the Applicant to gather information about the Applicant. Creating an applicant profile based on the gathered information about the Applicant and comparing the applicant profile to an exemplar employee profile to determine if the Applicant is a good match for a job position that corresponds to the job application. Sending the applicant's profile, the exemplar employee profile, the comparison result, and the job application to a review contact.

### BACKGROUND

The present invention relates generally to the field of evaluating job seeking candidates, and more particularly to evaluating the qualifications of a job seeker and comparing them to the qualifications of an example employee to determine if the job seeker is a good candidate.

When a corporation posts a job opening the amount of job applicants can vary from a few to hundreds or more. The amount of time it can take a Human Resources (HR) Professional to evaluate the job applicants can be a few minutes to a few weeks or more. Even after evaluating the job applicants it is not easy for HR professionals to identify applicants who will be a good candidate for a position.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for talent acquisition. A method comprises receiving a job application from an Applicant, wherein the job application includes a resume and analyzing the job applicant of the Applicant to gather information about the Applicant. Creating an applicant profile based on the gathered information about the Applicant and comparing the applicant profile to an exemplar employee profile to determine if the Applicant is a good match for a job position that corresponds to the job application. Sending the applicant's profile, the exemplar employee profile, the comparison result, and the job application to a review contact.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram of a talent acquisition processing environment, in accordance with an embodiment of the present invention.

FIG. 2 is an example of a plurality of exemplar employee profiles, in accordance with an embodiment of the present invention.

FIG. 3 is a flowchart depicting operational steps for creating exemplar employee profiles for job positions within the talent acquisition processing environment of FIG. 1, in accordance with an embodiment of the present invention.

FIG. 4 is a flowchart depicting operational steps for creating candidates' profiles from applicant resume and determining if the candidate is a good match for an open job position within the talent acquisition processing environment of FIG. 1, in accordance with an embodiment of the present invention.

FIG. 5 is a block diagram of components of a computing device of the talent acquisition processing environment of FIG. 1, in accordance with embodiments of the present invention.

FIG. 6 depicts a cloud computing environment according to an embodiment of the present invention.

FIG. 7 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for evaluating applicants for a job position. A setup phase needs to occur where exemplar employee profiles are created for each job position. The exemplar profiles are profiles of current employees who are successful at their current position. Each profile contains multiple characteristics, such as, educational level, technical expertise, area of technical expertise, network ability, business development, teamwork, innovation, pay your seat, continued learning, leadership skill, sales performance, etc. . . . . Each job position has a list of characteristics that are relevant to the job position. Multiple profiles are generated for each job position because successful employees have the different qualifications or experiences. Multiple employees who are successful at each position are identified and an exemplar profile is created for each of the employees. The exemplar profile rates each characteristic/capability in the exemplar employee profile based on the identified successful employee. The rating can be on a scale system (i.e. 1 to 10), star system, a text system (i.e. some, good, moderate, strong, very strong), or some other type of rating system. A perfect employee will have the highest rating in each characteristic/capability in the exemplar profile relating to his position, but a perfect employee does not exist. Multiple successful employees at same position can have different ratings for each characteristic/capability in the exemplar profile relating to each employee in each in the same position. Each characteristic/capability is weighted since the characteristic/capability can be more important in one job position over another job position. For example, a management position will have the characteristic of leadership rated higher than, for example, pay for your one seat. Every position within a company requires their own set of characteristic/capability for employee to be successful. A database is created that stores a plurality of exemplar employee profiles for each job position within the company.

An Applicant can apply for a job by applying in person, through the mail, through a referral, or by applying online. The Applicant usually provides a resume that includes pertinent information about qualifications and experiences of the Applicant. The resume could point to outside sources that contain information about the Applicant, for example, professional journals, outside website (for example, LINKEDIN, INDEED, or other website), or other locations that might contain information about the Applicant. Another source of information could be the job application. For example, the job application could also ask the Applicant different questions for the Applicant to answer when applying for a position.

By utilizing natural language processing methods information about the Applicant can be extracted from the Applicant's resume and other available material. An applicant profile is created by generating characteristics/capabilities based on the information on the Applicant and generating a rating for each of the characteristics/capabilities based on the information on the Applicant. The applicant's profile is compared to the exemplar profiles of the position that the applicant is applying for. The comparison determines how close and how far the applicant's ratings are from the exemplar ratings. If the comparison determines the applicant's profiles falls within a threshold of the exemplar, then the applicant's application is forwarded on to the Human Resources (HR) professional for consideration. The applicant's profile is provided to the HR professional for their review to see why the applicant was recommended for the position.

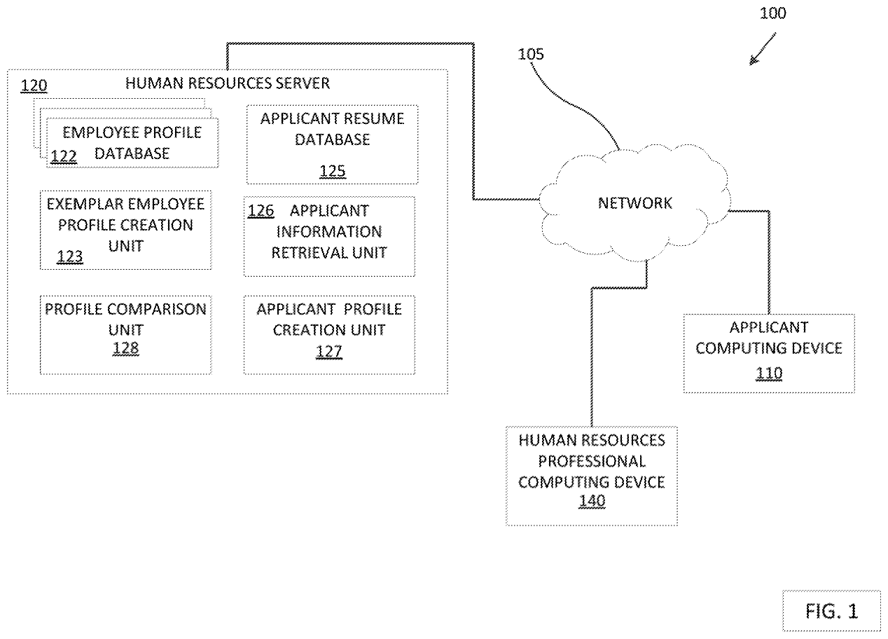

FIG. 1 is a functional block diagram of a talent acquisition processing environment 100, in accordance with an embodiment of the present invention.

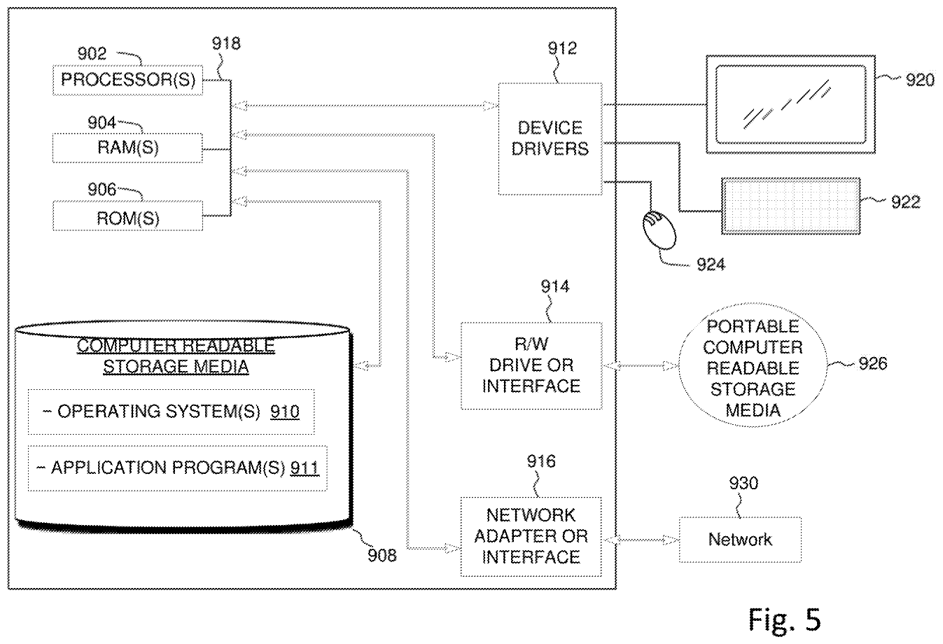

Applicant computing device 110 may be a laptop computer, tablet computer, netbook computer, personal computer (PC), a desktop computer, a personal digital assistant (PDA), a smart phone, or any programmable electronic device capable of communicating with human resources server 120 via network 105. The applicant computing device 110 allows for the Applicant to compose his resume and submit his job application to the human resources server 120. The applicant computing device 110 can be applicant's computer or it can be the computer of a recruiter who applies for jobs on behalf of a client. The applicant computing device 110 may include internal and external hardware components, as depicted, and described in further detail with respect to FIG. 5.

HR professional computing device 140 may be a laptop computer, tablet computer, netbook computer, personal computer (PC), a desktop computer, a personal digital assistant (PDA), a smart phone, or any programmable electronic device capable of communicating with human resources server 120 or the applicant computing device via network 105. The human resources (HR) professional computing device 140 allows for the HR professional to review an applicant's resume, the applicant's profile (which will be described below), the results of the comparison, and other pertinent information. The HR professional computing device 140 may include internal and external hardware components, as depicted, and described in further detail with respect to FIG. 5.

Network 105 can be, for example, a local area network (LAN), a wide area network (WAN) such as the Internet, or a combination of the two, and can include wired, wireless, or fiber optic connections. In general, network 105 can be any combination of connections and protocols that will support communications between human resources server 120, the applicant computing device 110, and the HR professional computing device 140.

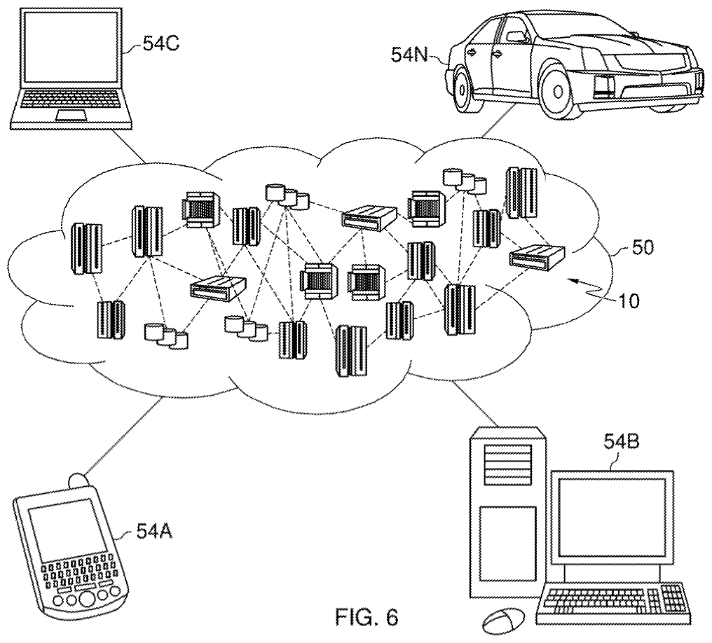

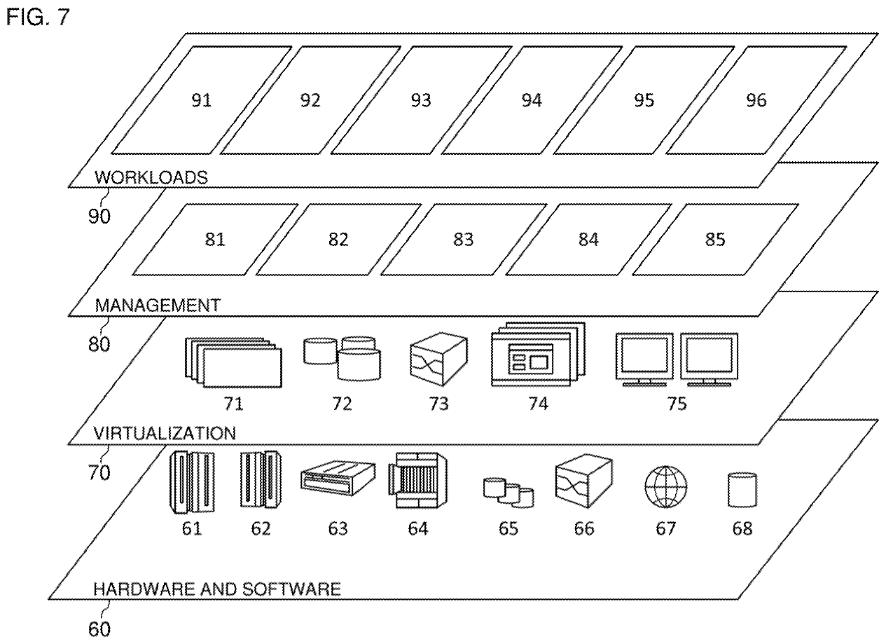

The human resource server 120 can includes an employee profile database 122, an exemplar employee profile creation unit 123, an applicant resume database 125, an applicant information retrieval unit 126, an applicant profile create unit 127, and a profile comparison unit 128. The human resources server 120 may be a laptop computer, tablet computer, netbook computer, personal computer (PC), a desktop computer, a personal digital assistant (PDA), a smart phone, or any programmable electronic device capable of communicating with the of HR professional computing device 140, and applicant computing device 110. In other embodiments, user HR server 120 may include internal and external hardware components, as depicted and described in further detail below with respect to FIG. 5, and operate in a cloud computing environment, as depicted in FIGS. 6 and 7.

A corporation can have a few job positions to many job positions within their internal structure. The internal structure of the corporation can include multiple of the same job positions or multiple of different job positions and the corporation can have multiple employees who are successful at the current job position. Employees who are successful in their job positions within the company are identified, by other employees within the company, through employee reviews, and/or by their employee personnel records. Once these employees are identified, the available information about each employee can be used to create an exemplar employee profile for each of the employee current job positions. The exemplar employee profile can be created to help current employees on career and skill development, which can be tracked over time. Exemplar employee profile consists of a list of key success characteristics/capabilities, which are specifically defined for each job position. The success characteristics/capabilities in the exemplar employee profile can include, for example, educational level, technical expertise, area of technical expertise, network ability, business development, teamwork, innovation, pay your seat (i.e. the employee is able to generate enough revenue to pay his salary), continued learning, leadership skill, sales performance, or a different characteristic. Each job position has a unique list of characteristics/capabilities that are used in the exemplar profile. The exemplar employee profile contains a rating for each of the characteristics/capabilities, where the ratings are based on the information about the current employee that each of the exemplar profiles is based on. The rating can be, for example, a scale system (i.e. 1 to 10), star system, a text system (i.e. some, good, moderate, strong, very strong, or something similar), or some other type of rating system. Every job position in a company is different and some characteristics/capabilities are more important for one job position and other characteristics/capabilities are more important for other job positions. The important characteristics/capabilities are identified for each position so that a weighting factor can be applied to those important characteristics/capabilities. Therefore, each characteristics/capability are weighted based on their importance to being success at the current position.

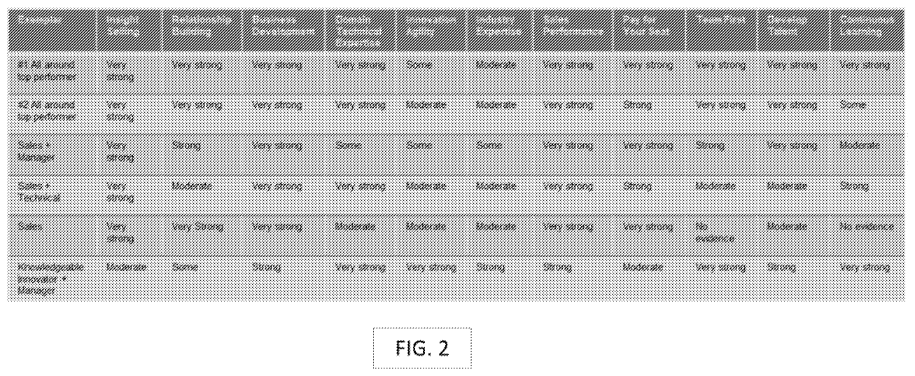

The exemplar employee profile creation unit 123 receives information about successful employees at different job positions and generates an exemplar employee profile for each job position. The exemplar employee profile creation unit 123 generates a plurality of exemplar employee profiles for each job position, where each of the plurality of exemplar employee profiles for one job position is based on different employees. A plurality of exemplar employee profiles is generated for each job position since multiple employees can be successful at the same job position while each of the employees have different qualifications, experiences, characteristics, and capabilities. The exemplar employee profile creation unit 123 generates a rating for each of the characteristics/capabilities in the exemplar employee profile, where the ratings are based on the information about the current employee that each of the exemplar profiles is based on. FIG. 2 illustrates a plurality of exemplar employee profiles that include the list of characteristics/capabilities and the rating given to each characteristic/capability for that exemplar employee profile. The goal is to find applicants who have a profile like the exemplar employee.

The exemplar employee profiles are stored in the employee profile database 122. The exemplar employee database 122 is a datastore that allows for storing, modification and/or deletion of exemplar employee profiles.

The human resources server 120 receives resumes and job applications from a plurality of different applicant computing devices 110. The resumes and job application are stored in the applicant resume database 125. The application profile creation unit 127 utilizes natural languages processing API to review the received resumes to determine if the resume makes references to outside sources of information corresponding to the Applicant. The outside sources that contain information about the Applicant can be, for example, professional journals, outside website (for example, LINKEDIN, INDEED, or other website), or other locations that might contain information about the job applicant. The application profile creation unit 127 provides the location of the outside sources of information to the applicant information retrieval unit 126. The applicant information retrieval unit 126 retrieves information about the Applicant that is contained in the outside sources identified by the application profile creation unit 127. Additionally, the Applicant can provide the links to the outside sources of information in the job application. The applicant information retrieval unit 126 retrieves information about the applicant that is contained in the identified outside sources that the applicant identified in his job application.

The application profile creation unit 127 uses a variety of natural language processes (NLP) methods to infer the applicant's personality and other job-related characteristics from the applicant's resume and from the outside sources of information. The application profile creation unit 127 uses the NLP with other advanced analysis and machine learning algorithms to infer applicant's personality and job-role specific characteristics that are analogs for characteristics/abilities associated with the exemplar profile for the position the applicant is applying for. Using sales position as an example, the applicant profile creation unit 127 needs to infer a candidate's relative sales experiences and business development capabilities. To do this, the application profile creation unit 127 combine companies and organizations identified by NLP with industry information available through 3rd party sources to link companies with industries. The applicant profile creation unit 127 infers the applicant's characteristics/capabilities based on resume/profile and advanced analysis results. For example, if the applicant profile creation unit 127 identifies sales experience on the resume (from work experience, closed deals listed, sales data listed, sales awards, etc. . . . ) and assigns that characteristic (i.e. sales) to the applicant profile. Based on the information contained within the resume or the outside sources of the information the applicant profile creation unit 127 assigns a rating to the characteristic of sales. The applicant profile creation unit 127 utilizes the same rating system as the exemplar employee profile creation unit 123. Another example, if the applicant profile creation unit 127 identifies technical experience on the resume (from education level, certifications, technical journal publication, patents issued, etc. . . . ) and assigns that characteristic to the applicant profile. The applicant profile creation unit 127 identifies as many characteristics/capabilities that are contained within the resume and/or outside sources. The information contained within the resume or the outside sources may be used multiple times to identified different characteristics/capabilities to be added to the applicant profile by the applicant profile creation unit 127.

The profile comparison unit 128 receives the applicant's profiles from the applicant profile creation unit 127 and retrieves the exemplar employee profiles from the exemplar employee database 122 for the position the applicant is applying for. The profile comparison unit 128 compares the characteristics/capabilities of the applicant profile to the characteristics/capabilities of the exemplar employee profile to determine which characteristics/capabilities appear on both profiles and which ones appear on only one of the profiles. The profile comparison unit 128 compares the rating for each of the characteristics/capabilities that appear on both applicant profile and on an exemplar employee profile to determine if each of the ratings on the applicant profile is higher, equal to, or lower than each of the ratings on the exemplar employee profile. Different characteristics/capabilities and different weighting factors applied to the characteristics/capabilities are used to describe different types of job position. For example, for a sales position, the characteristic/capabilities for business development and paying for your seat will have a greater importance than educational level or innovation.

The profile comparison unit 128 determines the score of the applicant's profile by calculating the distance from an applicant to each exemplar (Score=minimum distance between candidate and exemplars). The profile comparison unit 128 scores the applicant profile based on the number of ratings that are equal to or greater than the ratings on the exemplar employee profile. When the score of the applicant profile is higher than a first threshold value then the profile comparison unit 128 forwards the resume, application, applicant profile, and the comparison to the HR professional computing device 140 for final evaluation. The results displayed to HR professional computing device 140 also include which type of exemplars an applicant was closest to, in addition to the applicant's relative scores on the various success capabilities. This allows recruiters and hiring managers to get a better sense of how an applicant might fit into an existing team.

When the applicant score is below the first threshold value than the profile comparison unit 128 looks at the weighting factor on each of characteristic/capabilities on the exemplar profile and applies the weighting factor to the relevant ratings on the applicant's profile. The profile comparison unit 128 determines a weighted score for the applicant profile based on the weighted ratings for the characteristics/capabilities of the applicant profile. When the weighed score of the applicant profile is higher than a second threshold value then the profile comparison unit 128 forwards the resume, application, applicant profile, and the comparison to the HR professional computing device 140 for final evaluation.

When the applicant weighted score is below the second threshold value then the profile comparison unit 128 retrieves exemplar employee profile for open job positions. The profile comparison unit 128 performs the comparison of the applicant's profile to the exemplar employee profiles of the open job positions. When the applicant's profile receives a sufficient score then the profile comparison unit 128 forwards the resume, application, applicant profile, the original job position the applicant applied for indicating that the applicant is not a good match for, the new open job position (that the applicant did not apply for) that the applicant is a good match for, and the comparison to the HR professional computing device 140 for final evaluation. When the it is determined that the applicant's profile is not a good comparison to any of the exemplar employee profiles representing the current open job positions then the Applicant is informed that he is no longer being considered for the position he applied for and the Applicant is encourage to apply again at a later date.

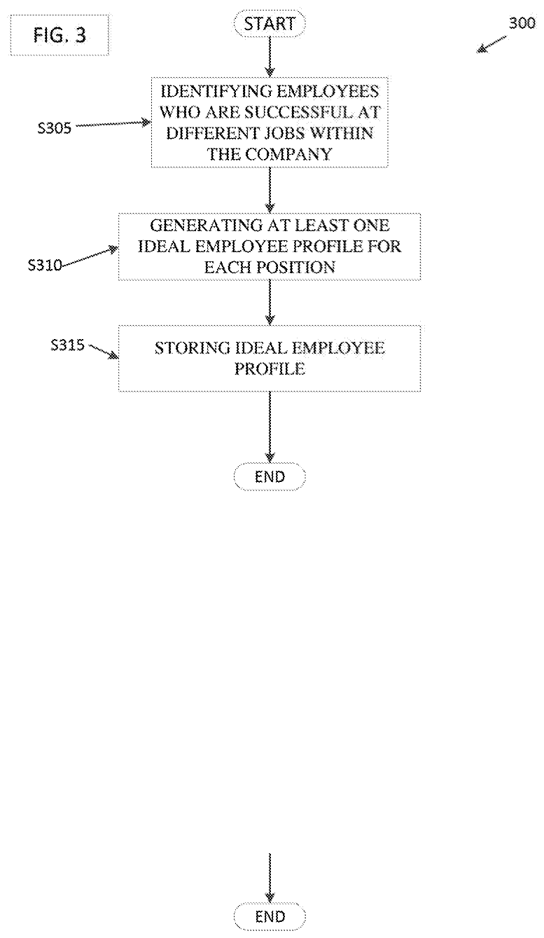

FIG. 3 is a flowchart depicting operational steps for creating exemplar employee profiles for job positions within the talent acquisition processing environment 100 of FIG. 1, in accordance with an embodiment of the present invention.

During the set-up phase current employees are identified who are successful in their current job positions within the company (S305). Multiple employees are identified for each job position, since a created exemplar employee profile for each employee will be unique, since no two employees are the same (S305). Once the employees are identified then the information about each of the identified employees is gathered, the information can be their personnel file, manager reviews, journal publications, patents issued, etc. The exemplar employee profile creation unit 123 creates exemplar employee profiles from the gathered information about the current employees (S310). The exemplar employee profile contains a unique list of characteristics/capabilities that were determined to be utilized for the job position. From the successful employee current in the job positions the characteristics/capabilities list is generated and the employee is rated for each of the characteristics/capabilities. The exemplar employee profile creation unit 123 generates a plurality of exemplar employee profiles for each position, where each of the plurality of exemplar employee profiles is based on different employees. The exemplar employee profile creation unit 123 generates a rating for each of the characteristics/capabilities in the exemplar employee profile, where the ratings are based on the current employee that is used for each of the exemplar profiles (S310). The exemplar employee profile is stored in the employee profile database 122 (S315).

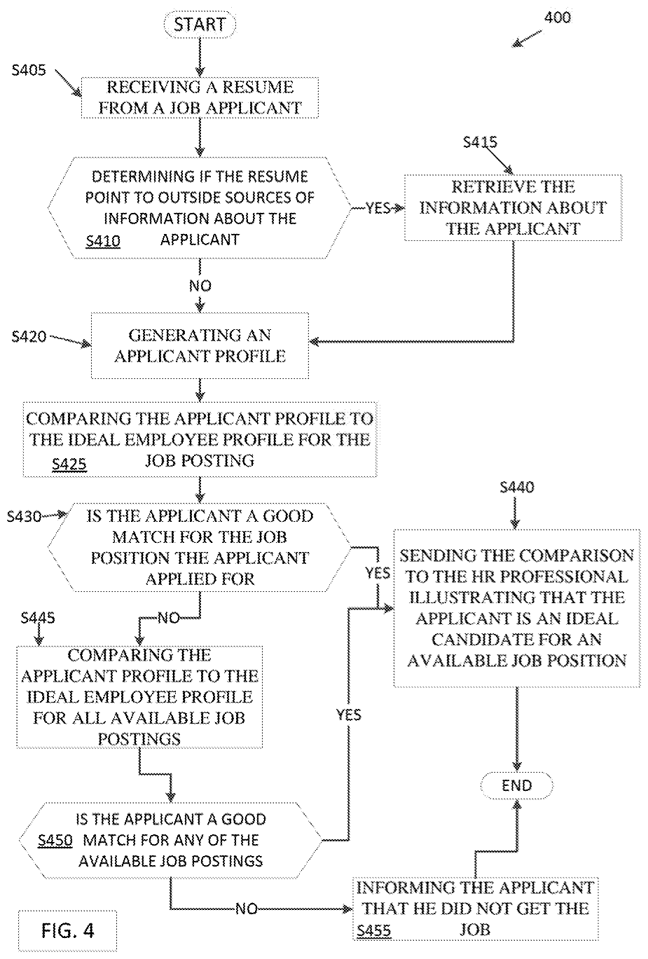

FIG. 4 is a flowchart depicting operational steps for creating candidates' profiles from applicant resume and determining if the candidate is a good match for an open job position within the talent acquisition processing environment 100 of FIG. 1, in accordance with an embodiment of the present invention.

The human resources server 120 receives an application from an applicant (S405). The applicant can include a resume, a job application (which can contain answers to questions set up by the company for the applicant to answer), a list or links to outside sources of information about the applicant (S405). The application profile creation unit 127 utilizes natural languages processing API to review the received resumes to determine if the resume has references to outside sources of information corresponding to the applicant (S410). The outside sources of information on the applicant can be, for example, professional journals, outside website (for example, LINKEDIN, INDEED, or other website), or other locations that might contain information about the job applicant. The application profile creation unit 127 provides the location of the outside sources of information to the applicant information retrieval unit 126 (S415). The applicant information retrieval unit 126 retrieves information about the applicant that is contained in the outside sources identified by the application profile creation unit 127 (S415). Additionally, the Applicant can provide the links to the outside sources of information in the job application. The applicant information retrieval unit 126 retrieves information about the applicant that is contained in the identified outside sources that the applicant identified in his job application (S415).

The application profile creation unit 127 receives the information about the applicant, i.e. resume, job applicant and outside source of information, and the application profile creation unit 127 creates an applicant profile (S420). The application profile creation unit 127 uses a variety of natural language process (NLP) methods to infer the applicant's personality and other job-related characteristics from the applicant's resume and from the outside sources of information. The application profile creation unit 127 uses the NLP with other advanced analysis and machine learning algorithms to infer applicant's personality and job-role specific characteristics that are analogs for characteristics/abilities associated with the exemplar profile for the position the applicant is applying for. Using sales position as an example, the applicant profile creation unit 127 needs to infer a candidate's relative knowledge in their client's industry. To do this, the application profile creation unit 127 combine companies and organizations identified by NLP with industry information available through 3rd party sources to link companies with industries. The applicant profile creation unit 127 infers the applicant's characteristics/capabilities based on resume/profile NLP & advanced analysis results. The applicant profile creation unit 127 uses NLP methods by analyzing the applicant's resume and the outside sources of information (if identified). For example, if the applicant profile creation unit 127 identifies sales experience on the resume (from work experience, closed deals listed, sales data listed, sales awards, etc. . . . ) and assigns that characteristic (i.e. sales) to the applicant profile. Based on the information contained within the resume or the outside sources of the information the applicant profile creation unit 127 assigns a rating to the characteristic of sales. The applicant profile creation unit 127 utilizes the same rating system as the exemplar employee profile creation unit 123. Another example, if the applicant profile creation unit 127 identifies technical experience on the resume (from education level, certifications, technical journal publication, patents issued, etc. . . . ) and assigns that characteristic to the applicant profile. The applicant profile creation unit 127 identifies as many characteristics/capabilities that are contained within the resume and/or outside sources. The information contained within the resume or the outside surface may be used multiple times by the applicant profile creation unit 127 to identified different characteristics.

The profile comparison unit 128 receives the applicant profile and retrieves the exemplar employee profiles from the employee profile database 122 for the job position the applicant is applying for (S430). The profile comparison unit 128 scores the applicant profile against the exemplar employee profile to determine if the applicant is a good match for the job position the applicant is applying for (S430). When the profile comparison unit 128 determines that the applicant is a good match to the job position he is applying for, then the profile comparison unit 128 transmits the application, applicant profile, and the comparison to the HR professional computing device 140 for final evaluation (S440). The results displayed to HR professional computing device 140 also include which type of exemplars an applicant was closest to, in addition to the applicant's relative scores on the various success capabilities. This allows recruiters and hiring managers to get a better sense of how an applicant might fit into an existing team.

When the profile comparison unit 128 determines that the applicant is not a good match for the position the applicant is applying for, then the profile comparison unit 128 retrieves the exemplar profiles from the employee database 122 for all open job positions (S445). The profile comparison unit 128 scores the applicant profile against all the exemplar employee profile to determine if the applicant is a good match for the any of the open job positions (S445). When the profile comparison unit 128 determines that the applicant is a good match to any open job position then the profile comparison unit 128 transmits the application, applicant profile, and the comparison to the HR professional computing device 140 for final evaluation (S440). When the profile comparison unit 128 determines that the applicant is not a good match for any of the open job positions then the Applicant is informed that he is no longer being considered for the position he applied for and the Applicant is encouraged to apply again at a later date.

FIG. 5 depicts a block diagram of components of applicant computing device 110, human resources server 120, and HR professional computing device 140 of talent acquisition processing environment 100 of FIG. 1, in accordance with an embodiment of the present invention. It should be appreciated that FIG. 5 provides only an illustration of one implementation and does not imply any limitations regarding the environments in which different embodiments may be implemented. Many modifications to the depicted environment may be made.

HR server 120, applicant computing device 110, and HR professional computing device 140 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications, and network processors, etc.), system memory, peripheral devices, and any other hardware components within a system.

One or more operating systems 910, and one or more application programs 911, for example, applicant profile creation unit 127 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

HR server 120, applicant computing device 110, and HR professional computing device 140 may also include a R/W drive or interface 914 to read from and write to one or more portable computer readable storage media 926. Application programs 911 on HR server 120, applicant computing device 110, and HR professional computing device 140 may be stored on one or more of the portable computer readable storage media 926, read via the respective R/W drive or interface 914 and loaded into the respective computer readable storage media 908.

HR server 120, applicant computing device 110, and HR professional computing device 140 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on HR server 120, applicant computing device 110, and HR professional computing device 140 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

HR server 120, applicant computing device 110, and HR professional computing device 140 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and applicant profile creation unit 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method comprising:
receiving, by a computer, a job application from an Applicant, wherein the job application includes a resume;
analyzing, by the computer, the job applicant of the Applicant to gather information about the Applicant;
creating, by the computer, an applicant profile based on the gathered information about the Applicant;
comparing, by the computer, the applicant profile to an exemplar employee profile to determine if the Applicant is a good match for a job position that corresponds to the job application; and
sending, by the computer, the applicant's profile, the exemplar employee profile, the comparison result, and the job application to a review contact.

2. The method of claim 1, wherein the creating the applicant profile comprises:
determining, by the computer, a plurality of characteristics or capabilities relating to the Applicant from the resume and/or job application; and
applying, by the computer, a rating to each of the plurality of characteristics or capabilities.

3. The method of claim 2, wherein the rating is a scale system.

4. The method of claim 2, the exemplar employee profile includes plurality of characteristics or capabilities corresponding to the job position relating an example employee the exemplar employee profile was based on.

5. The method of claim 4, wherein the comparing the applicant profile to an exemplar employee profile comprises:
comparing, by the computer, the plurality of characteristics or capabilities on the applicant profile to the plurality of characteristics or capabilities on the exemplar profile; and
comparing, by the computer, the ratings for each of the plurality of characteristics or capabilities on the applicant profile to each of the ratings for each of the plurality of characteristics or capabilities on the exemplar profile.

6. The method of claim 5, further comprises:
calculating, by the computer, a score for the applicant profile based on the comparison of the applicant profile to the exemplar employee profile, when the calculated score is above a threshold value than it is determined that the Applicant is a good match for a job position that corresponds to the job application.

7. The method of claim 1, further comprises:
determining, by the computer, that the job application or the resume points to outside sources of information about the Applicant; and
retrieving, by the computer, the information about the Applicant from the outside sources of information.

8. The method of claim 1, further comprising:
wherein analyzing the job application comprises utilizing, by the computer, natural language process methods to analyze the job application to determine the information contained within the job application;
wherein the creating of the application profile comprises listing a plurality of characteristics and capabilities based on the analyzed information from contained within the job application; and
wherein the creating of the application profile comprising applying the ratings for each of the plurality of characteristics and capabilities based on the analyzed information from contained within the job application.

9. A computer program product comprising:
one or more non-transitory computer-readable storage media and program instructions stored on the one or more non-transitory computer-readable storage media, the program instructions comprising:
program instructions to receive a job application from an Applicant, wherein the job application includes a resume;
program instructions to analyze the job applicant of the Applicant to gather information about the Applicant;
program instructions to create an applicant profile based on the gathered information about the Applicant;
program instructions to compare the applicant profile to an exemplar employee profile to determine if the Applicant is a good match for a job position that corresponds to the job application; and
program instructions to send the applicant's profile, the exemplar employee profile, the comparison result, and the job application to a review contact.

10. The computer program product of claim 9, wherein the creating the applicant profile comprises:
program instructions to determine a plurality of characteristics or capabilities relating to the Applicant from the resume and/or job application; and
program instruction to apply a rating to each of the plurality of characteristics or capabilities.

11. The computer program product of claim 10, wherein the rating is a scale system.

12. The computer program product of claim 10, the exemplar employee profile includes plurality of characteristics or capabilities corresponding to the job position relating an example employee the exemplar employee profile was based on.

13. The computer program product of claim 12, wherein the comparing the applicant profile to an exemplar employee profile comprises:
program instructions to compare the plurality of characteristics or capabilities on the applicant profile to the plurality of characteristics or capabilities on the exemplar profile; and
program instructions to compare the ratings for each of the plurality of characteristics or capabilities on the applicant profile to each of the ratings for each of the plurality of characteristics or capabilities on the exemplar profile.

14. The computer program product of claim 13, further comprises:
program instruction to calculate a score for the applicant profile based on the comparison of the applicant profile to the exemplar employee profile, when the calculated score is above a threshold value than it is determined that the Applicant is a good match for a job position that corresponds to the job application.

15. The computer program product of claim 9, further comprises:
program instructions to determine that the job application or the resume points to outside sources of information about the Applicant; and
program instructions to retrieve the information about the Applicant from the outside sources of information.

16. The computer program product of claim 9, wherein creating the applicant profile comprises:
wherein analyzing the job application comprises utilizing, by the computer, natural language process methods to analyze the job application to determine the information contained within the job application;
wherein the creating of the application profile comprises listing the plurality of characteristics and capabilities based on the analyzed information from contained within the job application; and
wherein the creating of the application profile comprising applying the ratings for each of the plurality of characteristics and capabilities based on the analyzed information from contained within the job application.

17. A computer system comprising:
one or more computer processors, one or more computer-readable storage media, and program instructions stored on one or more of the computer-readable storage media for execution by at least one of the one or more processors, the program instructions comprising:
program instructions to receive a job application from an Applicant, wherein the job application includes a resume;
program instructions to analyze the job applicant of the Applicant to gather information about the Applicant;
program instructions to create an applicant profile based on the gathered information about the Applicant;
program instructions to compare the applicant profile to an exemplar employee profile to determine if the Applicant is a good match for a job position that corresponds to the job application; and
program instructions to send the applicant's profile, the exemplar employee profile, the comparison result, and the job application to a review contact.

18. The computer system of claim 17, wherein the creating the applicant profile comprises:
program instructions to determine a plurality of characteristics or capabilities relating to the Applicant from the resume and/or job application; and
program instruction to apply a rating to each of the plurality of characteristics or capabilities.

19. The computer system of claim 18, the exemplar employee profile includes plurality of characteristics or capabilities corresponding to the job position relating an example employee the exemplar employee profile was based on.

20. The computer system of claim 19, wherein the comparing the applicant profile to an exemplar employee profile comprises:
program instructions to compare the plurality of characteristics or capabilities on the applicant profile to the plurality of characteristics or capabilities on the exemplar profile;
program instructions to compare the ratings for each of the plurality of characteristics or capabilities on the applicant profile to each of the ratings for each of the plurality of characteristics or capabilities on the exemplar profile; and
program instruction to calculate a score for the applicant profile based on the comparison of the applicant profile to the exemplar employee profile, when the calculated score is above a threshold value than it is determined that the Applicant is a good match for a job position that corresponds to the job application.
